(19) United States
(12) Patent Application Publication
(10) Pub. No.: US 2007/0041402 A1
(43) Pub. Date: Feb. 22, 2007

(54) Handling protocol non-compliant messages

(75) Inventors: Dhigha Sekaran, Redmond, WA (US); Orit Levin, Redmond, WA (US); Sunil Kumar Patro, Palo Alto, CA (US)

Correspondence Address: PERKINS COIE LLP/MSFT, P. O. BOX 1247, SEATTLE, WA, 98111-1247, US

(73) Assignee: Microsoft Corporation, Redmond, WA (US)

(21) Appl. No.: 11/205,785

(22) Filed: Aug. 16, 2005

(51) Int. Cl. H04J 3/16; H04J 3/24

(52) U.S. Cl. 370/469; 370/474

(57) ABSTRACT

A method and system for handling otherwise rejectable messages (e.g., out-of-order messages) sent using a communication protocol (e.g., SIP) is provided. When a message is received at a protocol layer of a client system, the message (or at least its information) is passed to a higher layer (e.g., an application layer) even if it is otherwise rejectable at the protocol layer. In this way, the protocol layer provides an application layer with the option of determining whether to discard the otherwise rejectable message. In some embodiments, the protocol layer may automatically acknowledge acceptance of the message, while in other embodiments, the protocol layer may wait to receive an indication from the higher layer to determine whether to acknowledge or negatively acknowledge acceptance of the message.

### BACKGROUND

Computer-implemented communication techniques that use messaging services are becoming increasingly common, and are employed in many contexts, including voice communication (e.g., Voice over IP (VoIP), instant messaging, real-time communication between applications, etc.). In general, messaging services require a networking protocol to establish and manage communications between participants. These services may use various mechanisms to establish sessions, including session protocols such as a “Session Initiation Protocol” (“SIP”). SIP is an application-layer control protocol that computer systems can use to discover one another and to establish, modify, and terminate sessions. SIP is an Internet proposed standard. Its specification, “RFC 3261,” is available at <http://www.ietf.org/rfc/rfc3261.txt>. A specification for extensions to SIP relating to event notifications, “RFC 3265,” is available at <http://www.ietf.org/rfc/rfc3265.txt>.

A SIP network comprises entities that can participate in a dialog as a client, server, or both. SIP supports four types of entities: user agent, proxy server, redirect server, and registrar. User agents initiate and terminate sessions by exchanging messages with other SIP entities. A user agent can be a user agent client (“UAC”), which is a device that initiates SIP requests, or a user agent server (“UAS”), which is a device that receives SIP requests and responds to such requests. As examples, “IP-telephones,” personal digital assistants, and any other type of computing device may be user agents. A device can be a UAC in one dialog and a UAS in another, or may change roles during the dialog. A proxy server is an entity that acts as a server to clients and a client to servers. In so doing, proxy servers intercept, interpret, or forward messages between UACs and UASs. A redirect server accepts a SIP request and generates a response directing the UAC that sent the request to contact an alternate network resource. A registrar is a server that accepts registration information from user agents and informs a location service of the received registration information.

SIP supports two message types: requests, which are sent from a UAC to a UAS, and responses, which are sent from a UAS to a UAC, when responding to a request. A SIP message is composed of three parts. The first part of a SIP message is a “request line,” which includes fields to indicate a message method (e.g., INVITE) and a Request URI that identifies the user or service to which the request is being directed. The second part of a SIP message comprises headers whose values are represented as name-value pairs. The third part of a SIP message is the message's body, which is used to describe the session to be initiated or contain data that relates to the session. Message bodies may appear in requests or responses.

The RFC 3261 specification specifies that a receiving agent (e.g., UAS or UAC) must reject any SIP response messages received out of sequence. The agent (at a session protocol layer) determines whether a response message is received out of sequence by checking the CSeq header of the response message against a counter, or similar mechanism. If a response message is received out of sequence, the agent returns an error response (e.g., a 500 (Server Internal Error)).

This approach may be sufficient in the context of simple messaging frameworks. However, in more complex cases, automatically rejecting an out-of-order (or otherwise protocol non-compliant) message can pose problems with respect to speed, performance, and efficiency of systems. One example of such a case is within the context of a publisher/subscriber model, where a publisher publishes information (e.g., messages containing presence information) to a server, which results in publication messages being sent to subscribers via SIP dialogs. In the case where one subscriber subscribes to the information of multiple publishers (e.g., a via a batch subscription), the publication messages for all publishers will be sent from the server to the subscriber via the same SIP dialog. The server may dedicate a thread to sending publication messages for a single publisher. Thus, the server will have multiple threads (e.g., one for each publisher) for generating the publications messages, which includes setting the correct sequence indicator (e.g., CSeq value) for each publication message so that the subscriber, upon receipt, knows that it is receiving the messages in a correct order. For example, when the server receives a message from a first publisher, that publisher's thread looks up the next sequence number (e.g., 1) for the subscriber's dialog and stores it in the publication message to be sent to the subscriber. In the meantime, before sending the publication message from the first publisher out to the subscriber, the server may receive a message from a second publisher. That second publisher's thread looks up the next sequence number (e.g., 2) for that subscriber and stores it in the publication message to be sent to the subscriber.

If for some reason (e.g., the particular timing of thread-to-CPU allocation), the respective server threads send out the publication message for the second publisher before sending out the publication message for the first publisher, the subscriber may receive messages out of order (i.e., message with CSeq 2 is received before message with CSeq 1). Even if the server sent out the messages in the correct order, the subscriber may not receive the messages in the correct order because the underlying transport protocol may not guarantee the order of message deliveries. According to protocols such as SIP, the out-of-order message “must” be rejected and the subscriber sends an error message so that the rejected information can be resent (or other appropriate action taken, such as refreshing a subscription to an entire batch in a batch subscription case) so that information is not ultimately lost. This rejection of messages results in a high resubscribe rate, thereby overburdening the server and decreasing performance.

### SUMMARY

A method and system for handling otherwise rejectable messages (e.g., out-of-order messages) sent using a communication protocol (e.g., SIP) are provided. The method and system, where appropriate, allow for a higher layer to determine the whether to accept or reject information in the received message. For example, every received message destined to a local application may be dispatched to the application and accompanied by the corresponding CSeq value of the SIP message. The application may then be responsible for either using the provided CSeq value or for introducing and using its own sequencing scheme to determine a manner of proceeding. This SIP layer may automatically accept all messages that are rejectable for certain reasons (e.g., out-of-order).

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

FIG. 1 is a block diagram that illustrates components of a general environment in which the system and method for handling out-of-order messages can be implemented in one embodiment.

FIG. 2 is a block diagram that illustrates components of an instant messaging environment in which the system and method for handling out-of-order messages can be implemented in one embodiment.

FIG. 3 is a block diagram that illustrates components of a batch subscription environment in which the system and method for handling out-of-order messages can be implemented in one embodiment.

FIG. 4 is a networking diagram showing the flow of packets in a batch subscription environment in one embodiment, such as the batch subscription environment of FIG. 3.

FIG. 5 shows the contents of a NOTIFICATION message packet containing information for use by the system and method for handling out-of-order messages in one embodiment.

FIG. 6 is a flow diagram that illustrates an example of a routine performed at the session protocol layer for handling out-of-order messages in one embodiment.

FIG. 7 is a flow diagram that illustrates an example of a routine performed at the application layer for handling out-of-order messages in one embodiment.

### DETAILED DESCRIPTION

A method and system for handling otherwise rejectable messages (e.g., out-of-order or otherwise protocol non-compliant messages) sent using a communication protocol (e.g., SIP) is provided. In some embodiments, a message sent using the given protocol is received at a protocol layer of a computing device or agent. The protocol layer is ordinarily responsible for determining whether a message that does not satisfy the protocol should be accepted or rejected. For example, a SIP protocol layer is responsible for accepting or rejecting messages based on their sequence number. Instead of accepting or rejecting the message, however, the protocol layer passes the received message to a higher layer (e.g., an application layer). The higher layer then makes a decision of whether to accept or reject information in the message. In some embodiments, the protocol layer automatically acknowledges acceptance of every message it passes to the higher layer. In other embodiments, the protocol layer receives an indication from the higher layer regarding whether to positively or negatively acknowledge the message (e.g., with respect to a server from which the message is received).

For example, in some embodiments, when a session protocol layer receives an out-of-order session initiation protocol (SIP) message from a server, it forwards the message to an application layer instead of rejecting it as instructed by in the SIP specification. To illustrate, in the context of a SIP SUBSCRIBE/NOTIFY transaction relating to presence information, instead of sending a 500 error message back to the server upon receipt of the out-of-order message, the session protocol layer may, instead, send a 200 OK message to the server and pass the message information on to the application layer. The application layer then determines whether to discard the message or not (or how to otherwise proceed). For example, in the context of multiple messages originating from different sources, the application layer may refer to a table it uses to track the order of incoming messages from each source. In some embodiments, the application layer may use the CSeq number (in addition to or instead of a sequence number that the application itself provides) to determine the fate of the message (e.g., accepted, rejected, discarded, ignored, etc.).

Another example of a context in which the method and system for handling out-of-order messages sent using a session protocol (e.g., SIP) can be used includes communicating events within a Voice over IP framework that uses SIP. For example, as part of and after completing a SIP INVITE transaction, a dialog may be established that allows sending and receiving of asynchronous event messages between clients and a server. The events can be, for example, ringing, connected, disconnected, etc. If the messages indicating these events come out-of-order (e.g., such as a disconnected event being received before a connect event), then the application layer (not the session protocol layer) can decide whether the messages should be discarded.

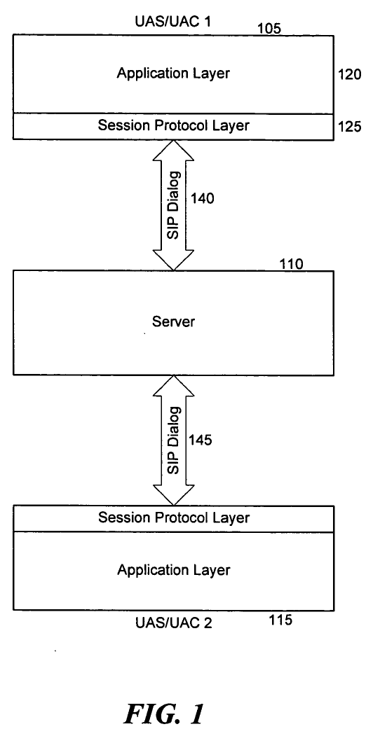

FIG. 1 is a block diagram that illustrates components of a general client/server environment in which the system and method for handling out-of-order messages can be implemented in one embodiment. The client/server environment is configured for communicating information via session initiation protocol (SIP). The environment may include computing device systems 105 and 115 that each function as both a user agent client (“UAC”) (which is a device that initiates SIP requests) and a user agent server (“UAS”) (which is a device that receives SIP requests and responds to such requests). As examples, “IP-telephones,” personal digital assistants, and any other type of computing device may be user agents. Accordingly, the computing device systems 105 and 115 can be a UAC in one dialog and a UAS in another, or may change roles during the dialog. A server 110 may be a proxy server that acts as a server to clients and a client to servers. In so doing, proxy servers intercept, interpret, or forward messages between computing devices 105 and 115 in their roles as both UACs and UASs.

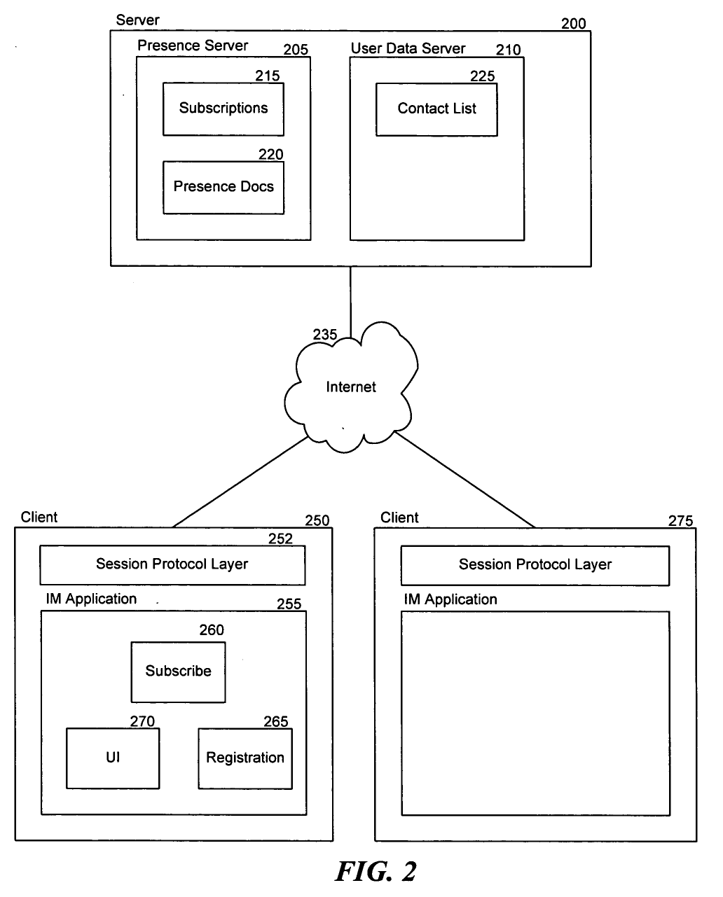

Each of the computing devices 105 and 115 may include an application layer 120 and a session protocol layer 125. Other layers (e.g., network layer, transport layer, data link layer, physical layer, etc.) may also be present, but are not shown. The session protocol layer 125 is primarily responsible for handling SIP-based communications. However, in accordance with some embodiments, determining whether to disregard an out-of order request may be handled by the application layer 120, as illustrated and described in more detail with respect to FIGS. 2-7.

FIG. 2 is a block diagram that illustrates components of an instant messaging environment in which the system and method for handling out-of-order messages may be implemented in one embodiment. An instant messaging service is made up of a server 200 connected to one or more instant messaging clients 250 and 275 through the Internet 235. The server 200 contains a presence server 205 and a user data server 210. The presence server 205 contains a subscriptions component 215 and a presence document store 220. The subscriptions component 215 maintains for each user the current list of users who are subscribed to that user's presence information. The presence document store 220 contains the presence document for each user indicating the user's current status on the instant messaging service. The user data server 210 maintains persistent data for each user and contains a contact list store 225. The contact list store 225 contains a list of each user's contacts. The server 200 provides the list of contacts of a user to the registered endpoints of that user.

The instant messaging clients 250 and 275 contain a session protocol layer 252 and an instant messaging application 255. The instant messaging application 255 contains a subscribe component 260, a registration component 265, and a user interface component 270, which receive message information from the session protocol layer 252. The subscribe component 260 subscribes to the presence information of the user's contacts. The registration component 265 registers the endpoint of the user with the instant messaging service and publishes updates to the user's presence information. The user interface component 270 provides windows and other graphical elements that are presented to the user while interacting with the instant messaging application 255. In a typical scenario, the user begins using the instant messaging service by starting the instant messaging application 255 at an endpoint. The application 255 invokes the registration component 265 to register the endpoint with the user data server 210 and presence server 205 and to retrieve the user's list of contacts and provide initial presence information about the user. The application 255 invokes the subscribe component 260 to subscribe to each of the user's contacts. The presence server 205 provides an initial presence document about each of the subscribed contacts, and sends an updated presence document when the presence for any of the contacts changes.

The computing devices on which the system is implemented may include a central processing unit, memory, input devices (e.g., keyboard and pointing devices), output devices (e.g., display devices), and storage devices (e.g., disk drives). The memory and storage devices are computer-readable media that may contain instructions that implement the system. In addition, the data structures and message structures may be stored or transmitted via a data transmission medium, such as a signal on a communication link. Various communication links may be used, such as the Internet, a local area network, a wide area network, a point-to-point dial-up connection, a cell phone network, and so on.

Embodiments of the system may be implemented in various operating environments that include personal computers, server computers, hand-held or laptop devices, multiprocessor systems, microprocessor-based systems, programmable consumer electronics, digital cameras, network PCs, minicomputers, mainframe computers, distributed computing environments that include any of the above systems or devices, and so on. The computer systems may be cell phones, personal digital assistants, smart phones, personal computers, programmable consumer electronics, digital cameras, and so on.

The system may be described in the general context of computer-executable instructions, such as program modules, executed by one or more computers or other devices. Generally, program modules include routines, programs, objects, components, data structures, and so on that perform particular tasks or implement particular abstract data types. Typically, the functionality of the program modules may be combined or distributed as desired in various embodiments.

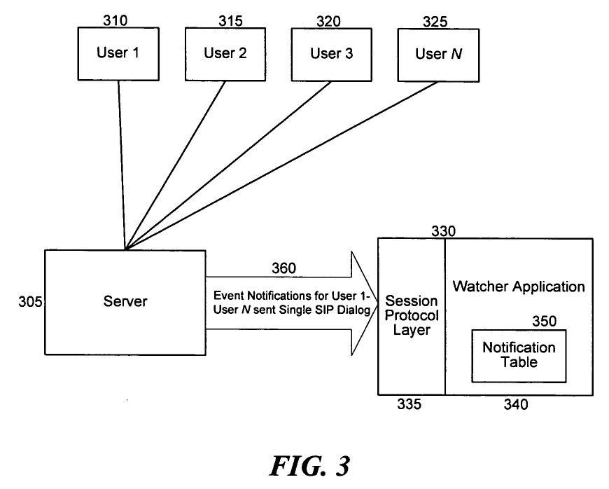

FIG. 3 is a block diagram that illustrates components of a batch subscription environment in which the system and method for handling out-of-order messages can be implemented in one embodiment. The environment includes multiple clients/users (310, 315, 320, and 325) that all communicate with a server 305 regarding their status and/or the occurrence of events. A fourth client 330 comprises a watcher component that watches events of the multiple users and communicates regarding the multiple clients/users (310, 315, 320, and 325) using a single SIP dialog 360. As with the clients/users (310, 315, 320, and 325) the watcher component 330 includes a session protocol layer 335 and a watcher application layer 340. In some embodiments, the watcher application layer 340 includes a notification table 350 that tracks incoming message information passed in from the session protocol layer 335, so that the session protocol layer 335 does not have to be responsible for determining whether to reject, discard out-of-order messages

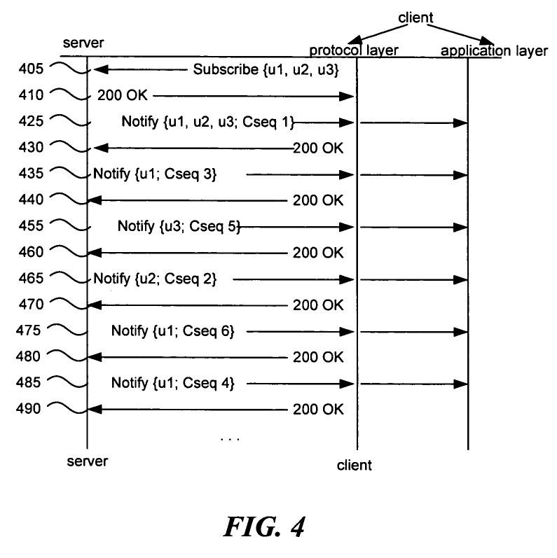

FIG. 4 is a network diagram showing the flow of message information between a server, a session protocol layer at a client, and an application layer at the client in the context of a batch subscription environment, such as the batch subscription environment of FIG. 3. For example, the messages shown may relate to providing presence information to a watcher component (the client). Arrows from the right to the left indicate messages sent from the client to the server, while arrows from the left to the right indicate messages sent from the server to the client. Time progresses moving down the diagram such that messages at the top of the diagram are sent earlier in time than those at the bottom. Assuming a SIP registration process has occurred with respect to each of the users in the batch, a first message includes a batch SUBSCRIBE request 405 sent from the client for u1, u2, and u3, followed by a 200 OK response 410 sent from the server. The server then sends a first NOTIFY request 415, which may include the initial presence documents for u1, u2, and u3. The CSeq value for this message is 1. In some embodiments, the message information (including the CSeq value) is passed from the client protocol layer to the client application layer. The client application may then use the CSeq value in a versioning table. An example of the versioning table after message 425 may be as follows:

TABLE A

| | Message |
|---|---|
| | 425 |
| u1 | 1 |
| u2 | 1 |
| u3 | 1 |

The receipt of message 425 is followed by 200 OK response 430 sent from the client session protocol layer, indicating that the message has been accepted. This notifies the server that it is acceptable to keep sending new messages. The server next sends a second NOTIFY request 435, which may include presence information for u1. In this example, the CSeq value for this message is 3, meaning that it is technically out of order (both with respect to the last message received and with respect to the messages received pertaining to u1), and the session protocol layer would ordinarily reject it. However, here in accordance with some embodiments, the session protocol layer does not automatically reject the out-of-order message 435 and, instead, passes the message information (including the CSeq value) to the client application layer. The client application layer may then use the CSeq value in the versioning table. An example of the versioning table after message 435 may be as follows:

TABLE B

| | Message | Message |
|---|---|---|
| | 425 | 435 |
| u1 | 1 | 3 |
| u2 | 1 | 1 |
| u3 | 1 | 1 |

Assuming the application layer did not reject the information associated with message 435, the receipt of message 435 is followed by 200 OK response 440 sent from the client session protocol layer, indicating that the message has been accepted. The server next sends a second NOTIFY request 445, which may include presence information for u2. In this example, the CSeq value for this message is 2. However, in accordance with some embodiments, the session protocol layer may not automatically reject (or accept) the out-of-order message 445 and, instead, may pass the message information (including the CSeq value) to the client application layer. The client application layer may then use the CSeq value in the versioning table. An example of the versioning table after message 445 may be as follows:

TABLE C

| | Message | Message | Message |
|---|---|---|---|
| | 425 | 435 | 445 |
| u1 | 1 | 3 | 3 |
| u2 | 1 | 1 | 2 |
| u3 | 1 | 1 | 1 |

Assuming the application layer did not reject the information associated with message 445, the receipt of message 445 is followed by 200 OK response 450 sent from the client session protocol layer, indicating that the message has been accepted. The server next sends a second NOTIFY request 455, which may include presence information for u3. In this example, the CSeq value for this message is 5. However, in accordance with some embodiments, the session protocol layer may not automatically reject the out-of-order message 455 and, instead, may pass the message information (including the CSeq value) to the client application layer. The client application layer may then use the CSeq value in the versioning table. An example of the versioning table after message 455 may be as follows:

TABLE D

| | Message | Message | Message | Message |
|---|---|---|---|---|
| | 425 | 435 | 445 | 455 |
| u1 | 1 | 3 | 3 | 3 |
| u2 | 1 | 1 | 2 | 2 |
| u3 | 1 | 1 | 1 | 5 |

Assuming the application layer did not reject the information associated with message 455, the receipt of message 455 is followed by 200 OK response 460 sent from the client session protocol layer, indicating that the message has been accepted. The server next sends a second NOTIFY request 465, which may include presence information for u1. In this example, the CSeq value for this message is 6, meaning again, it is out of order because a message with a CSeq value of 4 has not yet been received. However, in accordance with some embodiments, the session protocol layer may not automatically reject the out-of-order message 465 and, instead, may pass the message information (including the CSeq value) to the client application layer. The client application layer may then use the CSeq value in the versioning table. An example of the versioning table after message 465 may be as follows:

TABLE E

| | Message | Message | Message | Message | Message |
|---|---|---|---|---|---|
| | 425 | 435 | 445 | 455 | 465 |
| u1 | 1 | 3 | 3 | 3 | 6 |
| u2 | 1 | 1 | 2 | 2 | 2 |
| u3 | 1 | 1 | 1 | 5 | 5 |

Assuming the application layer did not reject the information associated with message 465, the receipt of message 465 is followed by 200 OK response 470 sent from the client session protocol layer, indicating that the message has been accepted. The server next sends a second NOTIFY request 475, which may include presence information for u1. In this example, the CSeq value for this message is 4, meaning again, it is out of order. In particular, the CSeq 4 is less than the last CSeq in which the client received the presence information for u1. The client application layer, in this case, may decide to drop/discard the notification. The table would remain in the previous state:

TABLE F

| | Mes- | Mes- | Mes- | Mes- | Mes- | Mes- |
|---|---|---|---|---|---|---|
| | sage | sage | sage | sage | sage | sage |
| | 425 | 435 | 445 | 455 | 465 | 475 |
| u1 | 1 | 3 | 3 | 3 | 6 | 6 |
| u2 | 1 | 1 | 2 | 2 | 2 | 2 |
| u3 | 1 | 1 | 1 | 5 | 5 | 5 |

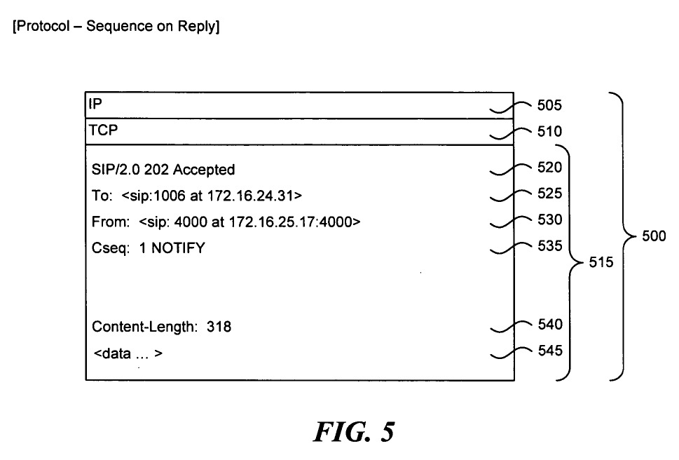

FIG. 5 shows the contents of a conventional NOTIFY message sent to a SIP client by a server that can be used in conjunction with the system and method for handling out-of-order messages in some embodiments. The packet 500 includes an IP header 505, a TCP header 510, and a SIP message 515. Protocols other than TCP/IP may be used for the underlying transport. The SIP message 515 includes a SIP message identifier 520, a To header 525, a From header 530, a CSeq header 535, a Content-Length header 540, and data/payload 545. While not shown, other types of headers or information may be present in the message 515. The SIP identifier 520 identifies the SIP version 2.0 and the status of the notification request 202. The To header 525 specifies which endpoint the sender of this packet is notifying. The From 530 header specifies the endpoint of the sender and is used to send acknowledgements receipt of the message once the notification is established. The CSeq header 535 is contained on every message, both requests and responses, from the SIP server and is traditionally used as a sequence number by the session protocol layer to determine the relative order of messages from the server. However, in some embodiments the session protocol layer does not act on the CSeq information and instead passes the information to the application layer (as described with respect to FIG. 4 above. A different sequence number is created for each SIP dialog, and the sequence number typically specifies the type of request that created the dialog. For example, as shown, the CSeq header 535 may have a value of 1 NOTIFY indicating that this is the first message from the server in the dialog created by a NOTIFY request between the endpoints specified by the To and From headers. Messages with a lower sequence number were sent from the server earlier than messages with a higher sequence number. The Content-Length header 540 has a value of 318 indicating that 318 bytes of data follow the SIP message header. The data 545 for a NOTIFY request typically specifies the presence document for the endpoint producing the notification.

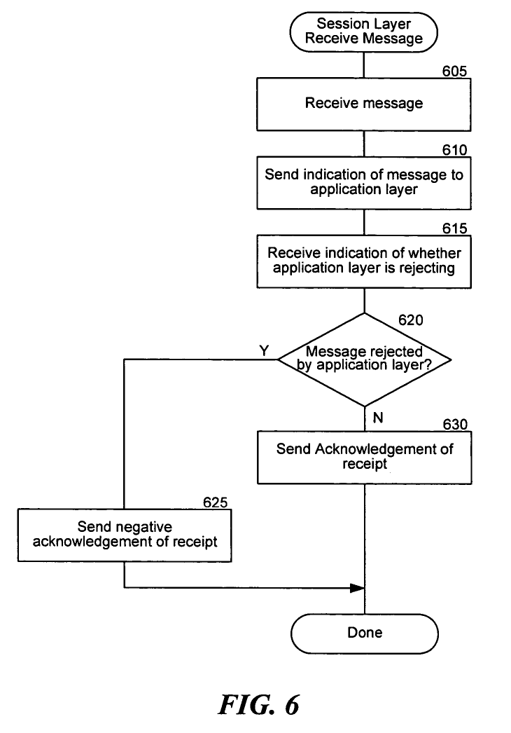

FIG. 6 is a flow diagram that illustrates a routine 600 for handling both in-order and out-of-order incoming SIP messages (e.g., SIP NOTIFICATOIN messages) at a session protocol layer associated with a SIP client in one embodiment. At block 605, the routine 600 receives a message from a server, such as a NOTIFICATION message that provides presence information. At block 610, the routine 600 sends an indication of the message to the application layer, instead of automatically acting on the message. In some embodiments, this will only occur for messages that appear to be sent out of sequence based on the sequence number value contained in the message (e.g., a CSeq value). In other embodiments, the routine 600 passes along all received messages, regardless of whether they appear to be out of order based on the sequence number.

Blocks 615, 620, 625 are not included in some embodiments, and may only occur in cases where the routine does not automatically acknowledge receipt of the message (regardless of the sequence it is received in). At block 615 the routine 600 receives an indication from the application layer as to whether it has rejected the message (if so, a new message may need to be sent). If, at decision block 620, the application layer has rejected the out-of-sequence message and needs a new message sent, the routine 600 sends a negative acknowledgement back to the server, so that the server will know to resend. If, however, at decision block 620, the application layer has not rejected the message (or if blocks 615, 620, and 625 are not performed), the routine 600 continues at block 630, where the session protocol layer sends an acknowledgement of receipt of the message (e.g., a 200 OK or an ACK). The routine 600 then ends

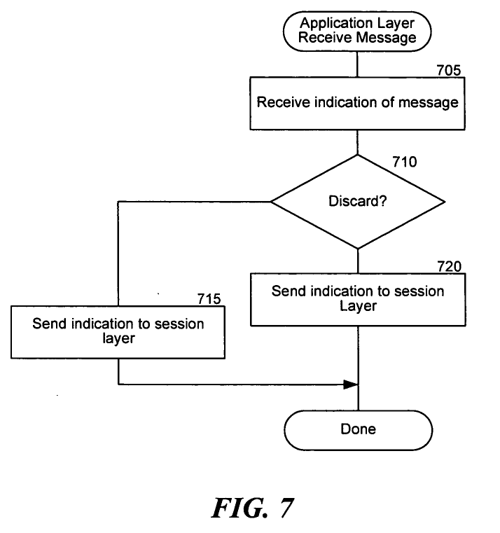

FIG. 7 is a flow diagram that illustrates an example of a routine performed at the application layer of a SIP client for handling out-of-order messages in one embodiment. At block 705, the routine 700 receives an indication that the session protocol layer has received an incoming SIP message (which may, or may not be received out-of-order). At decision block 710, the routine 700 determines whether to discard the message or not. This may be accomplished by using one or more techniques such as a table that tracks each incoming response (see e.g., FIG. 4 and corresponding text) or by relying on sequence information in the message payload. For example, the data or document contained in the message itself may include an indication of whether it needs to be received in order with respect to other messages, whether it includes complete or partial data, etc. If, at decision block 710, the routine 700 determines that the message should be discarded, it may discard the message and (optionally) send an indication that this is the case (block 715). Otherwise, if at decision block 710, the routine 700 determines that the message should not be discarded, it keeps the information from the message and (optionally) sends an indication of this to the session protocol layer (block 720). The routine 700 then ends or may be repeated for subsequent messages.

In some cases, the message being received from a server by the protocol layer contains only partially complete information, and if the protocol layer automatically discards the partial information (e.g., because it is received out of order), then the overall information provided to the application layer may be inconsistent. For example, in the context of applications relying on presence information, a SIP NOTIFY/SUBSCRIBE request may include only partial presence information for any particular user. In such a case, a first message that a subscriber receives may include a status of “online” and a substatus of “typing,” a second message that the subscriber receives (received out of order) may include only a substatus of “gone home,” and a third message that the subscriber receives (which should have actually been received before the second message) may include a status of “offline” and a substatus of “in a meeting.” The fact that the subscriber receives the messages out of order and that the second message that was received only contains partial information may sometimes cause problems. For example, the subscriber may believe that “gone home” is associated with an “online” status since it did not receive the offline/in a meeting message first. However, instead of the protocol layer automatically rejecting the second and/or third out-of order messages, the decision of whether to use or discard the information from these messages is passed from the protocol layer to the application layer, which may, for example, have capabilities to make this determination more intelligently than the protocol layer.

In some embodiments, to assist the application layer in making decisions, in some embodiments, a message (e.g., a message possibly containing partial information as described in the preceding paragraph) may also include information relating to whether or not the message may be optionally discarded. If this information specifies that the message containing partial information can be optionally discarded, then the application layer may turn to a version number associated with the partial information to determine whether to discard it or not (instead of or prior to requesting for the information to be refreshed). For example, in the case of a system utilizing a presence agent, once a subscription is accepted and installed, the presence agent may deliver the full state of requested presence information in a first notification that contains a presence document. Thus, if the presence agent decides to send notifications that include a presence document, the presence agent may need to build the presence document according to a specified format and, when dealing with a first notification within a subscription may need to initialize a “version” attribute to a value of 1. This version counter may be scoped to the subscription. Version may be reset when the given subscription is terminated, but not reset when the subscription is refreshed.

In another example, if a received notification contains full state, indicated by the <list attribute “fullState” set to “true”, the notification may used to update the table in the application. A check is first made to ensure that the “version” attribute of the <list> attribute in the received message is greater than the local version number. If not, the received document is discarded without any further processing. Otherwise, the contents of the resource-list table are flushed, and repopulated from the contents of the document. A new row in the table is created for each “resource” element. Alternatively, if a notification contains partial state, indicated by the <list> attribute “fullState” set to “false”, a check is made to ensure that no list notifications have been lost. The value of the local version number (the “version” attribute of the <list> element) is compared to the version number of the new document. If the value in the new document is exactly one higher than the local version number, the local version number is increased by one, and the document is processed accordingly. If the version in the document is more than one higher than the local version number, the local version number is set to the value in the new document, and the document is processed accordingly. The list subscriber may then generate a refresh request to trigger a full state notification. If the version in the document is less than or equal to the local version, the document is discarded without any further processing. For each resource listed in the document, the subscriber may check to see whether a row exists for that resource. This check may be done by comparing the Resource-URI value with the URI associated with the row. If the resource doesn't exist in the table, a row is added, and its state is set to the information from that “resource” element. If the resource does exist, its state is updated to be the information from that “resource” element, as described in the definition of the event package. If a row is updated or created such that its state is “terminated,” that entry may be removed from the table.

From the foregoing, it will be appreciated that specific embodiments of the system have been described herein for purposes of illustration, but that various modifications may be made without deviating from the spirit and scope of the invention. Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims. Accordingly, the invention is not limited except as by the appended claims.

I/we claim:

1. A method at a protocol layer in a computer system for handling messages sent using a protocol, the method comprising:
receiving a message sent using the protocol, wherein the protocol layer is ordinarily responsible for determining whether a message that does not satisfy the protocol should be accepted or rejected;
sending the received message to a higher layer; and
receiving from the higher layer an indication of whether to reject or accept the message.

2. The method of claim 1 wherein the message includes a sequence number ordinarily for use by the protocol layer to determine whether the message was received out-of-order with respect to the receipt of other messages.

3. The method of claim 1 wherein the message is related to an instant messaging transaction.

4. The method of claim 1 wherein the message is related to a Voice over IP transaction.

5. The method of claim 1 wherein the protocol is session initiation protocol (SIP).

6. The method of claim 1, further comprising, based on the received indication, at the protocol layer, either acknowledging or negatively acknowledging receipt of the message to a server.

7. The method of claim 1, further comprising, at the protocol layer, automatically acknowledging the receipt of the message regardless of whether the application layer rejects or accepts the message.

8. The method of claim 1 wherein the received message includes at least a portion of a presence document.

9. A computer-readable medium containing instructions for controlling aspects of a computing device at a protocol layer to perform a method comprising:
receiving a message sent using a protocol, wherein the protocol layer is ordinarily supposed to accept or reject the message based on whether it satisfies the protocol;
automatically accepting the message; and
passing the message to a higher layer, wherein the higher layer decides whether to use or discard information in the message.

10. The computer-readable of claim 9 wherein the message includes a sequence number for use by the protocol layer, and wherein the sequence number indicates that the message was received out-of-order with respect to other messages.

11. The computer-readable medium of claim 9 wherein the message is sent from a server, and wherein, if the higher layer determines that information in the message should be discarded, the method further comprises sending an indication to the server that the message should be resent.

12. The computer-readable medium of claim 9 wherein the message includes a payload that allows the higher layer to determine whether information from the message should be discarded.

13. The computer-readable medium of claim 9 wherein passing the message to the higher layer includes passing message content information and message sequence information.

14. The computer-readable medium of claim 9 wherein the higher layer is an application layer.

15. A method in a computer system for handling messages sent using a protocol, the method comprising:
at an application layer, receiving an indication of a first session initiation protocol (SIP) message sent to a session protocol layer, wherein a CSeq header of the first message includes a value n, where n corresponds to a discrete number indicating an order in which the message was sent to the session protocol layer;
at the application layer, receiving an indication of a second session initiation protocol (SIP) message sent to the session protocol layer, wherein a CSeq header of the second message includes a value m, and wherein m is less than n or not sequentially proximate to n, indicating that the second message was received by the session protocol layer out-of-order; and
at the application layer, determining whether the second session initiation protocol message should be treated as if it where rejected by the session protocol layer.

16. The method of claim 15 wherein determining whether the second session initiation protocol message should be treated as if it were rejected by the session protocol layer includes referencing information associated with the CSeq header that corresponds to the second message.

17. The method of claim 15 wherein the first message pertains to a first client in a batch process, and wherein the second message pertains to a second client in the batch process.

18. The method of claim 15 wherein the application layer uses a table to track the receipt of messages, and wherein the application layer uses the table in its determination of whether the second message should be treated as if it were rejected by the session protocol layer.

19. The method of claim 15, further comprising, at the application layer, providing an indication to the session protocol layer of whether the second message should be treated as if it were rejected by the session protocol layer.

20. The method of claim 15 wherein the application layer is associated with a batch subscribe application used to watch for events of multiple users that are using a single session initiation protocol (SIP) dialog for communication with a server.
